(19) United States
(12) Patent Application Publication
(10) Pub. No.: US 2006/0247355 A1
(43) Pub. Date: Nov. 2, 2006

(54) Insulating and thermally conductive resin composition, molded article and method of producing the composition

(76) Inventors: Wataru Kosaka, Ichihara-shi (JP); Takuji Harano, Neyagawa-shi (JP); Yoshikazu Inada, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/411,091

(22) Filed: Apr. 26, 2006

(30) Foreign Application Priority Data
Apr. 28, 2005 (JP) 2005-131583
Feb. 13, 2006 (JP) 2006-035183

(51) Int. Cl. C08K 3/08

(52) U.S. Cl. 524/439; 523/200

(57) ABSTRACT

To provide an insulating and thermally conductive resin composition from which a molded article having a high insulating properties and a high thermal conductivity can be produced and which is excellent in moldability, a molded article, and a method of producing the resin composition. The insulating and thermally conductive resin composition of the invention includes at least 30% by volume or more of a thermoplastic resin, 10 to 40% by volume of metallic aluminum type filler, and 5 to 25% by volume of a flame retardant. Particularly, addition of 1 to 10% by volume of a metal powder having a melting point of 500° C. or higher and 1 to 10% by volume of a low melting point alloy having a melting point of 500° C. or lower can provide more isotropic thermal conduction.

### BACKGROUND OF THE INVENTION

1. Field of the Invention

The present invention relates to an insulating and thermally conductive resin composition, a molded article and a method of producing the composition. More specifically, the present invention relates to an insulating and thermally conductive resin composition used for boxes or the like of electronic appliances, a molded article and a method of producing the composition, the resin composition having high insulating properties, a high thermal conductivity and excellent moldability.

2. Description of the Prior Art

As semiconductor devices such as LSI are made with increasingly higher degree of integration, their operating speeds become higher and electronic components are packaged with higher density, it has been increasingly important to dissipate heat generated in the electronic components. Casings for electronic components, for instance, have been made of metals or ceramics having high thermal conductivity, but resin-based materials have recently come into use that provide high degree of freedom in choosing the shape and ease of reducing the size.

For the resin-based material, such resin compositions have been used that comprise a matrix resin and a filler having high thermal conductivity, such as metal, alloy or ceramic, dispersed in the matrix resin (e.g. Japanese Laid-Open Patent Publication No. 5-239321). However, while metals can provide a high thermal conductivity, metals have a problem that since they have high electrical conductivity, they cannot provide electrical insulating properties to resin type materials. To deal with the problem, there is proposed a method of coating the surface of a powder having a high thermal conductivity with an electrical insulating coating (e.g. Japanese Laid-Open Patent Publication No. 8-183875).

### SUMMARY OF THE INVENTION

However, in the method of Japanese Laid-Open Patent Publication No. 5-239321, CVD is employed as the method of coating the surface of the powder having a high thermal conductivity with the electrical insulating coating, and this method inevitably costs high and therefore, a low cost resin type material is desired. Also, in the case of using a ceramic, the composition has to be highly filled with the ceramic to secure the thermal conductivity, and due to the high hardness, there occurs a problem that a kneading member of a molding apparatus is easily broken.

An object of the present invention is to solve the problems described above, and provide an insulating and thermally conductive resin composition, a method of producing the same and a molded article, the resin composition having a high electrical insulation, a high thermal conductivity and an excellent moldability.

To solve the above-mentioned problem, an insulating and thermally conductive resin composition of the present invention is characterized in that the resin composition comprises at least 30% by volume or more of a thermoplastic resin, 10 to 40% by volume of a metallic aluminum type filler, and 5 to 25% by volume of a flame retardant. The metallic aluminum type filler is generally known as conductive filler, however since it has a stable oxide film on the surface, it is a material expected to be usable as economical, insulating and thermally conductive filler. However, the metallic aluminum type filler is easy to be ignited and may possibly decompose a resin at the time of melting and kneading it with the resin. Further, non-flammability of the molded article cannot sufficiently be retained. In the present invention, the combustion reaction of the metallic aluminum type filler is suppressed at the time of melting and kneading it with the resin and the non-flammability of the molded article is secured by adding a flame retardant to the resin composition, so that prior to the heat generation of the metallic aluminum type filler, the flame retardant can shut heat and oxygen out of the metallic aluminum type filler by decomposition reaction, dehydration reaction etc. or decrease the temperature to suppress the combustion reaction. Accordingly, the metallic aluminum type filler can provide a thermal conductivity as high as 2 W/m·K or higher and high electrical insulating properties to a molded article formed from the resin composition. The flame retardant suppresses combustion of the thermoplastic resin attributed to the function similar to that described above.

In the present invention, the term “insulating properties” as used herein, means that the volume resistivity measured by a method according to JIS K6911 is 10¹⁰ Ω.cm or higher.

The above definition applies to the term as used throughout this specification, unless otherwise limited in specific instances.

As the metallic aluminum type filler to be used for the present invention, any one kind of substances selected from a group consisting of aluminum flakes, aluminum powders, aluminum fibers, and combinations of two or more thereof. That is, aluminum flakes, aluminum powders, or aluminum fibers may be used alone or two or more of them may be used in combination. Further, those whose surface is coated with a resin or a ceramic may be used as the aluminum flakes. An acrylic resin may be used as the resin.

Conventionally known organic flame retardants and inorganic flame retardants may be used as the flame retardant to be used in the present invention, and it is preferable to use a flame retardant containing an inorganic compound having a decomposition temperature of 300° C. or higher.

The resin composition of the present invention may further contain 1 to 10% by volume of a metal powder having a melting point of 500° C. or higher and 1 to 10% by volume of a low melting point alloy having a melting point of 500° C. or lower. This resin composition can be obtained by heating the low-melting point alloy to a temperature at which it is turned into a semi-molten state wherein solid phase and liquid phase coexist, and kneading the powder mixture of the low-melting point alloy, the metal powder, the metallic aluminum type filler, the flame retardant and the resin. Since viscosity of the low-melting point alloy is controlled to be higher than that of completely molten state by keeping the low-melting point alloy in the semi-molten state so as to minimize the difference in viscosity between the low-melting point alloy and the resin, the low-melting point alloy can be better dispersed in the resin. As a result, such a resin composition is obtained because the low-melting point alloy is dispersed more uniformly in the resin compared to a case where the low-melting point alloy is kneaded in completely molten state. The low-melting point alloy makes contact with or deposits to the thermally conductive filler so as to connect the thermally conductive filler to each other and thereby to form 3-dimensional paths for heat conduction. The low-melting point alloy dispersed uniformly in the resin binds the particles of the thermally conductive filler with less volume ratio than in the prior art, and forms the paths for heat conduction that are more uniformly distributed in the 3-dimensional space. Thus it is made possible to provide a resin composition that has high thermal conductivity where volume ratio of the matrix resin is set to 40 vol % or higher so as to maintain satisfactory moldability.

An insulating and thermally conductive resin molded article of the present invention is characterized in that it is obtained by heating a powder mixture containing at least 30% by volume or more of a thermoplastic resin, 10 to 40% by volume of a metallic aluminum type filler, and 5 to 25% by volume of a flame retardant, kneading the mixture while making the thermoplastic resin in melted state, and molding the kneaded mixture into a desired shape. Examples of the molded article may include an optical pick up base, a heat dissipation container for a semiconductor, a heat dissipation container for an optical-semiconductor, and a reflecting plate for a lamp.

A resin composition of the present invention can be obtained by heating a powder mixture containing at least a thermoplastic resin, metallic aluminum type filler and a flame retardant, kneading the mixture while making the thermoplastic resin in melted state, and molding the kneaded mixture into a desired shape. Further, the resin composition of the present invention including the above metal powder and low-melting point alloy can be produced by a process described below. That is, another method of producing a resin composition of the present invention is characterized in that a powder mixture including at least the matrix resin, the metallic aluminum type filler, the flame retardant, the metal powder having melting point not smaller than 500° C. and the low-melting point alloy having melting point not higher than 500° C. is heated so as to bring the low-melting point alloy into semi-molten state wherein solid phase and liquid phase coexist thereby to knead the low-melting point alloy and the matrix resin that is completely melted, and the mixture is molded into a desired shape.

Herein, as the metal powder, any one kind of metals selected from a group consisting of iron, copper, nickel, titanium, chromium, and combinations of two or more thereof may be used. As the low melting point alloy, at least one alloy selected from a group consisting of Sn-Cu, Sn-Al, Sn-Zn, Zn-Al, Sn-Mn, Sn-Ag, and Sn-Mg may be used.

The thermoplastic resin to be used in the present invention is preferably a crystalline resin having a melting point of 200° C. or higher and/or a non-crystalline resin having a glass transition temperature of 150° C. or higher.

### DETAILED DESCRIPTION OF THE PREFERRED EMBODIMENTS

This application is based on applications of No.2005-131583 filed Apr. 28, 2005 and No.2006-035183 filed Feb. 13, 2006 in Japan, the content of which is incorporated hereinto by references.

Hereinafter, the invention will be described along with the embodiments.

An insulating and thermally conductive resin composition of the present invention contains at least 30% by volume or more of a thermoplastic resin, 10 to 40% by volume of metallic aluminum type filler, and 5 to 25% by volume of a flame retardant.

A crystalline resin having a melting point of 200° C. or higher and/or a non-crystalline resin having a glass transition temperature of 150° C. or higher may be used as the thermoplastic resin to be used in the invention. Specific examples of the crystalline resin having a melting point of 200° C. or higher may include polyphenylene sulfides (PPS), polyether ether ketones (PEEK), syndiotactic polystyrenes (SPS), etc., and specific examples of the non-crystalline resin having a glass transition temperature of 150° C. or higher may include polysulfones (PSF), polyether sulfones (PES), polyether imides (PEI), polyamide imides (PAI), etc. Among these resins, PPS is more preferable. The reason is as follows. Since PPS has low viscosity upon melting, fillers are easily dispersed and thus a large amount of the fillers can be incorporated. Since PPS has high heat resistance, it is made possible to increase the degree of freedom in the selection of the low-melting point alloy.

At the time of kneading the resin with the fillers, the thermoplastic resin may be kneaded with the fillers at a temperature of melting point of the thermoplastic resin or higher, preferably in a range from 250° C. to 400° C. and even more preferably in a range from 300° C. to 350° C. The volume ratio of the resin is preferably 30% by volume or higher, and more preferably 40% by volume of higher to ensure good moldability.

Further, as the metallic aluminum type filler, any of aluminum powders, aluminum fibers and aluminum flakes may be used. Among these fillers, aluminum flakes are more preferable because aluminum flakes can be uniformly dispersed and has good insulating oxide film. The average particle diameter of the aluminum powders is 10 to 150 μm and more preferably 20 to 100 μm. The average diameter of the aluminum fibers is 10 to 150 μm and more preferably 15 to 100 μm and the length is 0.5 to 15 mm and more preferably 1 to 10 mm. In the case of aluminum flakes, the 150 μm sieve passing ratio is 98% or higher and more preferably 100 μm sieve passing ratio is 98% or higher. The volume ratio of the metallic aluminum type filler is 10 to 40% by volume and more preferably 10 to 35% by volume. This is because thermal conductivity decreases when the volume ratio is lower than 10 vol % and moldability of the resin composition deteriorates when the volume ratio is higher than 40 vol %.

The surface of the thermally conductive filler may be modified by means of a coupling agent or a sizing agent. Rendering the affinity for the matrix resin to the filler improves the dispersing characteristic of the thermally conductive filler in the matrix resin, and thereby to improve the thermal conductivity further. The coupling agents such as based on silane, titanium and aluminum can be used. For example, isopropyltriisostearoyl titanate and acetalkoxyaluminum diisopropylate may be used for metal powder. Epoxy resin, urethane-modified epoxy resin, polyurethane resin and polyamide resin may be used as the sizing agent for carbon fiber. Modification can be achieved by such a process as immersing the thermally conductive filler in a solution prepared by dissolving the coupling agent in water or an organic solvent for a predetermined period of time, or spraying a solution of the coupling agent onto the thermally conductive filler.

Also, metallic aluminum type filler having a surface coated with a resin or a ceramic may be used. The coating may further improve the electrical insulating properties and provides non-flammability to the metallic aluminum type filler and also suppresses scattering of the aluminum flake. Suppression of the scattering leads to improve the workability. Herein, at least a portion of the surface, more preferably the entire surface, of the metallic aluminum type filler is coated with a resin or a ceramic. Examples to be used as the resin may include fluoro resins, acrylic resins, epoxy resins, and urethane resins. Among these resins, Acrylic resin is more preferable. Examples to be used as the ceramic may include silica, aluminum, zirconia, and oxides of titanium. A coating method is not particularly limited, for example, a method of immersing the metallic aluminum type filler in a coating agent such as a liquid type resin coating agent or a ceramic coating agent for a predetermined period, or a method of spraying the coating agent to the metallic aluminum type filler and then firing or drying the metallic aluminum type filler can be employed. In this case, as the resin coating agent a resin dispersion or an organosol may be used, and as the ceramic coating agent sol of oxides such as silica and alumina or a solution of a metal alkoxide or metal chloride may be used.

The flame retardant to be used in the present invention is not particularly limited if it is capable of providing non-flammability to the metallic aluminum type filler. Conventionally known organic and inorganic flame retardants for resins can be used. Examples of the organic flame retardants may include halogen type flame retardants and phosphorus type flame retardants and examples of the inorganic flame retardants may include inorganic compounds such as metal hydroxide, metal oxide, metal carbonate, and mineral. The halogen type flame retardants are characterized by shutting oxygen and heat out of the metallic aluminum type filler and the resin by the hydrogen halide generated at the time of thermal decomposition of them and collecting produced radicals and examples thereof may include decabromodiphenyl oxide (DBDPO), octabromodiphenyl oxide, tetrabromobisphenol A (TBA), bis(tribromophenoxy)ethane, TBA polycarbonate oligomer, ethylene bis(tetrabromophthalimide), ethylene bis(pentabromodiphenyl), tris(tribromophenoxy)triazine, polystyrene bromide, and octabromotrimethylphenylindane. The phosphorus type flame retardants are characterized by shutting oxygen and heat out of the metallic aluminum type filler and the resin by the carbonized coating of polyphosphoric acid produced at the time of thermal decomposition of them and collecting produced radicals and examples thereof may include phosphoric acid esters, halogen-containing phosphoric acid esters, ammonium polyphosphate, red phosphorus, and phosphaphenanthrene. The metal hydroxides are characterized by suppressing combustion of the metallic aluminum type filler and the resin by cooling function by heat absorption at the time of thermal decomposition of them and examples thereof may include aluminum hydroxide, magnesium hydroxide, calcium hydroxide, barium hydroxide, zirconium hydroxide, zinc hydroxide, cerium hydroxide, titanium hydroxide, manganese hydroxide, strontium hydroxide, and hydrotalcite. Examples of the metal carbonates may include magnesium carbonate and examples of the minerals may include kaolin, talc, zeolite, borax, and boehmite. To knead these flame retardants with a resin, in the case of a thermoplastic resin, it is required to heat to a range from 250° C. to 400° C. as described above. Therefore, in the case of using a thermoplastic resin, it is preferable to use a flame retardant having a decomposition temperature of about 300° C. or higher. Specific examples of the flame retardants may include, in the case of halogen type flame retardant, decabromodiphenyl oxide, TBA polycarbonate oligomer, ethylene bis(tetrabromophthalimide), ethylene bis(pentabromodiphenyl), tris(tribromophenoxy)triazine, polystyrene bromide, and octabromotrimethylphenylindane and in the case of inorganic flame retardants, magnesium hydroxide, calcium hydroxide, magnesium carbonate and boehmite. One or more of these flame retardants may be used. The flame retardant suitable for use in the present invention is magnesium carbonate or boehmite, more preferably boehmite.

The resin composition of the present invention is preferable to further contain a metal powder having a melting point of 500° C. or higher and a low melting point alloy having a melting point of 500° C. or lower. The low melting point alloy makes contact with or deposits to the metallic aluminum type filler particles so as to connect the metallic aluminum type filler particles to each other and thereby to form three-dimensional paths for heat conduction. The low melting point alloy dispersed uniformly in the resin binds the metallic aluminum type filler particles with less volume ration than in the prior art, and forms the paths for heat that are more uniformly distributed in the three dimensional apace, and accordingly contributes to more isotropic heat conduction. That is, generally, filler is dispersed while being oriented in a prescribed direction in accordance with the particle shape. In the case where the orientation property is significant, the heat conduction becomes anisotropic that is, the heat conduction is high only in a special direction and heat conduction is insufficient in other directions. However, since the low melting point alloy makes contact with or deposits to the metallic aluminum type filler particles so as to connect the metallic aluminum type filler particles to each other and thereby to form three-dimensional paths for heat conduction, so that the filler can provide more isotropic heat conduction. The metal powder particles are also connected with the low melting point alloy, so that the low melting point alloy further contributes to isotropic heat conduction.

Suitable low melting point alloys for use in the present invention include those which are to be in semi-molten state at a melting temperature of the above-mentioned heat resistant resin, more preferably alloys having a melting point of 500° C. or lower. Specific examples of the alloys may include Sn-Cu, Sn-Al, Sn-Zn, Sn-Mn, Sn-Ag, Sn-Mg, and Zn-Al. More preferably alloys having a melting point of 400° C. or lower, that is, at least one kind of alloys selected from a group consisting of Sn-Cu, Sn-Al, Sn-Zn, and Zn-Al may be used, since the option of the selection of the resin to be kneaded together can be widened. Further preferably, at least one kind of alloys selected from a group consisting of Sn-Cu, Sn-Al, and Sn-Zn may be used, since they are readily available at low cost. Further more preferably, Sn-Cu may be used, since use of such alloy makes it possible to increase the degree of freedom in the selection of the range of the melting point and to achieve the high thermal conductivity. The particle diameter of the low melting point alloy is preferably 5 mm or smaller. It is because if the particle diameter is larger than 5 mm, it takes a long time to melt the alloy and it becomes difficult to disperse the alloy uniformly in the thermoplastic resin. In addition, the shape is not particularly limited and any shape such as spherical, tear droplet-like, bulk type, dendrite type shape may be employed.

The metal powder suitable for use in the present invention includes any one kind of metals selected from a group consisting of iron, copper, nickel, titanium, chromium, and combinations of two or more thereof, and more preferably copper, iron or nickel.

The content by volume of the low melting point alloy suitable for use in the present invention is 1 to 10% by volume and more preferably 1 to 7% by volume. It is because when the content is less than 1% by volume, the low melting point alloy demonstrates insufficient isotropic heat conduction and when the content is more than 10% by volume, the amount of the low melting point alloy with low thermal conductivity is increased to result in decrease of the thermal conductivity. Also, the content by volume of the metal powder is 1 to 10% by volume and more preferably 1 to 5% by volume. It is because when the content is less than 1% by volume, the metal powder demonstrates insufficient isotropic heat conduction and when the content is more than 10% by volume, the electric insulation property is decreased. Additionally, the content by volume of the metal powder is preferably smaller than that of the low melting point alloy. It is because if the content by volume of the metal powder is higher than that of the low melting point alloy, decrease of the electrical insulating properties is more significant than the effect of providing isotropic heat conduction.

The resin composition of the present invention may optionally include a fibrous filler or calcium carbonate to improve the strength and the flexural modulus of the molded article. Preferred fibrous filler may include metal fibers of the above exemplified metals, glass fibers (e.g. chopped fiber and milled fiber), alumina fibers, calcium titanate fibers, silicon nitride fibers, and whiskers (e.g. potassium titanate whisker, calcium metasilicate whisker, and aluminum borate whisker).

The resin composition of the present invention may be molded in a desired shape by previously dry blending the resin, the filler, the flame retardant, and the like; supplying the resulting blend to a uniaxial or biaxial kneading extruder; melting and kneading the blend; producing pellets by granulating the blend thereafter; and molding the pellets into a desired shape by using an injection molding apparatus, a compressive molding apparatus, and an extrusion molding apparatus having a prescribed die. The kneading temperature is preferably in a range of the kneading temperature of the resin when adding a low melting point alloy and it is preferable to set the temperature of the low melting point alloy so that solid phase and liquid phase can coexist. A Henshel mixer, a super mixer, a tumbler or the like may be used for the dry blending. If necessary, in the case where the metal powder has a high density, the metal powder may be dry blended and supplied (side-fed) separately from the resin during the extrusion and then kneaded. Also, the fibrous filler may be side-fed and kneaded separately from the metal powder.

Since the resin composition of the present invention is excellent in moldability and has high thermal conductivity, the molded article of the composition is suitable for a heat dissipation material for electronic parts. Examples of the product may include an optical pick up base, a heat dissipation container for a semiconductor, a heat dissipation container for an optical-semiconductor, a reflecting plate for a lamp, a casing for a fan motor, a housing for a motor core, a case of a secondary battery, and also a box for a personal computer and a mobile phone. The optical pick up base using the resin composition of the present invention has a sufficient heat dissipation property for maintaining the light emitting property of a light emitting element such as laser and lightweight as compared with metallic ones and therefore movable at a high transportation speed, so that the access speed to an optical disk can be increased considerably high. Further, examples of the heat dissipation container for a semiconductor may include a housing of a semiconductor device such as a power transistor and a diode and an ECU (electronic control unit) for a vehicle. Examples of heat dissipation container for an optical-semiconductor may include housing for a light emitting device such as LED. Examples of the reflecting plate for a lamp may include reflecting plates for a back light of a liquid crystal display, a facsimile apparatus, a scanner lamp of a scanner apparatus, and a head lamp for an automobile.

The following examples are provided to describe the invention in further detail. These examples, which set forth a preferred mode presently contemplated for carrying out the invention, are intended to illustrate and not to limit the invention.

### Examples

Sample Production

Polyphenylene sulfide (PPS) was used for a resin; aluminum flakes (45 μm sieve passing ratio of 98%, manufactured by Toyo Aluminium K. K.) and acrylic resin-coated aluminum flakes (63 μm sieve passing ratio of 97%, manufactured by Toyo Aluminium K. K.) for metallic aluminum type fillers; magnesium carbonate (average particle diameter of 1.7 μm, manufactured by KONOSHIMA CHEMICAL CO., LTD.) or boehmite (average particle diameter of 2 μm, manufactured by Kawai-Lime) for a flame retardant; a copper powder (average particle diameter of 20 to 25 μm, manufactured by Nikko Materials Co., Ltd.) for a metal powder; and a Sn-Cu alloy powder (average particle diameter of 25 μm) for a low melting point alloy. The alloy having a 4 to 30% Cu-Sn composition was used so as to bring the alloy into semi-molten state at the time of kneading the alloy with the resin.

Each of the raw material powder mixtures of compositions shown in Table 1 was charged into an extrusion kneading machine, where the mixture was mixed and kneaded at a temperature of 290 to 310° C. and was extruded in the form of pellets. The pellets were molded by a hot press to make samples of cylindrical shape measuring 50 mm in diameter and 5 mm in thickness for the measurement of the thermal conductivity and the electrical insulating properties.

For comparison, samples using alumina (average particle diameter of 35 μm, manufactured by Micron Co., Ltd.) and boron nitride (average particle diameter of 0.85 μm, manufactured by Mitsui Chemicals Inc.) as the thermally conductive fillers were also produced.

Heat Conductivity Measurement

A steady heat flow meter (model No. TCHM-DV) manufactured by DYNATEC R&D, Corp. was used. At the time of measurement, to accurately measure the temperature difference between the top and the bottom faces of each sample, CC (copper-constantan) thermocouples were embedded in the top and bottom surfaces of the disc shaped sample by hot press in order to monitor precisely the temperature difference between the surfaces during measurement. Hot press process enables it to improve the flatness of the sample and decrease contact resistance between the sample and the thermocouple. Measurement was made after keeping the sample at a predetermined temperature for one hour in order to stabilize the heat conduction. The measured values of thermal conductivity are shown in Table 1 and Table 2. To investigate the anisotropy of thermal conductivity, measurement was carried out while the thickness direction of the sample was adjusted to be the same as the direction of the heat flow at the time of measurement (this is called as non-oriented direction and referred to as non-orientation for short), and the longitudinal direction of the sample was adjusted to be the same as the direction of the heat flow at the time of measurement (this is called as oriented direction and referred to as orientation for short). As the ratio of the thermal conductivity of non-orientation and orientation is closer to 1, more isotropic thermal conduction can be obtained. Although depending on the shape, the filler was generally oriented in the extrusion direction and therefore, dispersed while being oriented in the longitudinal direction of the molded article.

Measurement of Electrical Insulating Properties

According to JIS K6911, the volume resistivity and applied voltage were measured. To measure the volume resistivity, HP 16008B measurement cell and HP 4339A high resistance meter were employed. In this connection, to lower the contact resistance, conductive rubber sheets were set on the top and the bottom faces of the sample, respectively. The results are shown in Table 1 and Table 2.

Flammability Test

A vertical flammability test standardized in UL94 was carried out. The results are shown in Table 1 and Table 2.

TABLE 1-1

| | | Example 1 | Example 2 | Example 3 | Example 4 | Example 5 | Example 6 |
|---|---|---|---|---|---|---|---|
| PPS | | 60 | 58 | 52 | 44 | 57 | 52 |
| Al flakes | | 25 | 25 | 25 | 25 | 25 | 25 |
| Resin-coated Al flakes | | — | — | — | — | — | — |
| Al₂O₃ | | — | — | — | — | — | — |
| BN | | — | — | — | — | — | — |
| Cu | | — | 1 | 3 | 6 | 3 | 3 |
| Sn—Cu | | — | 1 | 5 | 10 | 5 | 5 |
| MgCO₃ | | 15 | 15 | 15 | 15 | 10 | — |
| AlOOH | | — | — | — | — | — | 15 |
| Thermal conductivity | Orientation | 6 | 6 | 5 | 4 | 5.5 | 6 |
| (W/(m · K)) | Non-orientation | 0.8 | 1 | 1.5 | 2 | 1.5 | 1.5 |

| | | | | | | |
|---|---|---|---|---|---|---|
| Insulating properties | | | | | | |
| Applied voltage: V | 450 V | 450 V | 430 V | 400 V | 430 V | 430 V |
| Volume resistivity: Ω · cm | 10¹⁶ | 10¹⁶ | 10¹⁵ | 10¹³ | 10¹⁵ | 10¹⁵ |
| UL vertical flammability | Equivalent | Equivalent | Equivalent | Equivalent | Equivalent | Equivalent |
| | to V-1 | to V-1 | to V-1 | to V-1 | to V-1 | to V-1 |

TABLE 1-2

| | | Example 7 | Example 8 |
|---|---|---|---|
| PPS | | 67 | 58 |
| Al flakes | | — | — |
| Resin-coated Al flakes | | 25 | 30 |
| Al₂O₃ | | — | — |
| BN | | — | — |
| Cu | | 3 | 1 |
| Sn—Cu | | 5 | 1 |
| MgCO₃ | | — | — |
| AlOOH | | 10 | 10 |
| Thermal conductivity | Orientation | 3.5 | 5 |
| (W/(m · K)) | Non-orientation | 1 | 1 |

| | | |
|---|---|---|
| Insulating properties | | |
| Applied voltage: V | 450 V | 500 V |
| Volume resistivity: Ω · cm | 10¹⁶ | 10¹⁶ |
| UL vertical flammability | Equivalent | Equivalent |
| | to V-1 | to V-1 |

TABLE 2

| | | Comparative | Comparative | Comparative | Comparative | Comparative |
|---|---|---|---|---|---|---|
| | | Example 1 | Example 2 | Example 3 | Example 4 | Example 5 |
| PPS | | 75 | 50 | 70 | 64 | 37 |
| Al flakes | | 25 | — | — | 25 | 25 |
| Al₂O₃ | | — | 50 | — | — | — |
| BN | | — | — | 30 | — | — |
| Cu | | | | | 3 | 3 |
| Sn—Cu | | | | | 5 | 5 |
| MgCO₃ | | | | | — | — |
| AlOOH | | | | | 3 | 30 |
| Thermal conductivity | Orientation | 7 | 2 | 1.3 | 6 | Impossibility |
| (W/(m · K)) | Non-orientation | 0.8 | 1.7 | 0.7 | 1.5 | of kneading |

| | | | | | |
|---|---|---|---|---|---|
| Insulating properties | | | | | due to excess |
| Applied voltage: V | 500 V | 500 V | 500 V | 430 V | filling |
| Volume resistivity: Ω · cm | 10⁹ | 10¹⁵ | 10¹⁵ | 10¹⁵ | |
| UL vertical flammability | No V class | V-0 | V-0 | No V class | |

Results

In these examples, aluminum flakes were used as the aluminum type filler and magnesium carbonate was used as a flame retardant, so that the non-flammability could be improved from no V class to V-1 class while the volume resistivity of 10¹⁰ Ω·cm or higher, insulating properties of 100 V or higher applied voltage, and thermal conductivity of 2 W/m·K or higher were maintained. Further, in the case where a copper powder and Sn-Cu alloy were added, the ratio of thermal conductivity in the oriented direction and thermal conductivity in the non-oriented direction (orientation thermal conductivity/non-orientation thermal conductivity) was lowered as compared with that in the case of no addition and for example, addition of 3% by volume or more of a copper powder and 5% by volume or more of Sn-Cu could lower (orientation thermal conductivity/non-orientation thermal conductivity) to 3 or lower. Further, as being made clear by comparison of the results of examples 3 and 6, if boehmite was used in place of magnesium carbonate, the thermal conductivity could be further improved. Also, as being made clear by comparison of the results of examples 6 and 7, when resin-coated aluminum flakes were used in place of resin-un-coated aluminum flakes, the insulating properties could be further improved.

As will be clearly seen from the foregoing description, as compared with a conventional resin composition containing a ceramic type filler, the resin composition of the present invention contains a lowered filling ratio of the filler, has a low specific gravity, and is excellent in the moldability owing to use of the metallic aluminum type filler and the flame retardant. Accordingly, the present invention can provide a resin composition suitable for a highly insulating and thermally conductive molded article.

What is claimed is:

1. An insulating and thermally conductive resin composition comprising at least 30% by volume or more of a thermoplastic resin, 10 to 40% by volume of a metallic aluminum type filler, and 5 to 25% by volume of a flame retardant.

2. The resin composition according to claim 1, wherein the metallic aluminum type filler is any one kind of substances selected from a group consisting of aluminum flakes, aluminum powders, aluminum fibers, and combinations of two or more thereof.

3. The resin composition according to claim 2, wherein the surface of the aluminum flakes is coated with a resin or a ceramic.

4. The resin composition according to claim 3, wherein the resin is an acrylic resin.

5. The resin composition according to claim 1, wherein the flame retardant is an inorganic compound having a decomposition temperature of 300° C. or higher.

6. The resin composition according to claim 1 further comprising 1 to 10% by volume of a metal powder having a melting point of 500° C. or higher and 1 to 10% by volume of a low melting point alloy having a melting point of 500° C. or lower.

7. The resin composition according to claim 6, wherein the metal powder is any one kind of metals selected from a group consisting of iron, copper, nickel, titanium, chromium, and combinations of two or more thereof

8. The resin composition according to claim 6, wherein the low melting point alloy is at least one kind of alloys selected from a group consisting of Sn-Cu, Sn-Al, Sn-Zn, Zn-Al, Sn-Mn, Sn-Ag, and Sn-Mg.

9. The resin composition according to claim 1, wherein the thermoplastic resin is a crystalline resin having a melting point of 200° C. or higher and/or a non-crystalline resin having a glass transition temperature of 150° C. or higher.

10. The resin composition according to claim 1 having a thermal conductivity of 2 W/m·K or higher.

11. A molded article formed from an insulating and thermally conductive resin composition comprising at least 30% by volume of a thermoplastic resin, 10 to 40% by volume of metallic aluminum type filler, and 5 to 25% by volume of a flame retardant.

12. The molded article according to claim 11, wherein the molded article is an optical pick-up base.

13. The molded article according to claim 11, wherein the molded article is a heat dissipation container for a semiconductor.

14. The molded article according to claim 11, wherein the molded article is a heat dissipation container for an optical semiconductor.

15. The molded article according to claim 11, wherein the molded article is a reflecting plate for a lamp.

16. A method of producing an insulating and thermally conductive resin composition, comprising heating a powder mixture containing at least a thermoplastic resin, a metallic aluminum type filler, and a flame retardant so as to bring the thermoplastic resin into molten state, kneading the mixture, and molding the mixture into a desired shape.

17. The method according to claim 16, wherein the powder mixture further contains a metal powder having a melting point of 500° C. or higher and a low melting point alloy having a melting point of 500° C. or lower, and wherein the method comprises heating the mixture so as to bring the low melting point alloy into a semi-molten state in which a solid phase and liquid phase coexist and also the thermoplastic resin into molten state, kneading the mixture, and molding the mixture into a desired shape.
